(19) United States
(12) Patent Application Publication
(10) Pub. No.: US 2010/0030474 A1
(43) Pub. Date: Feb. 4, 2010

(54) DRIVING SUPPORT APPARATUS FOR VEHICLE

(75) Inventor: Shinji Sawada, Tokyo (JP)

Correspondence Address: HAYNES AND BOONE, LLP;IP Section, 2323 Victory Avenue, Suite 700, Dallas, TX, 75219, US

(73) Assignee: Fuji Jukogyo Kabushiki Kaisha, Tokyo (JP)

(21) Appl. No.: 12/492,380

(22) Filed: Jun. 26, 2009

(30) Foreign Application Priority Data
Jul. 30, 2008 (JP) 2008-196583

(51) Int. Cl. G08G 1/16

(52) U.S. Cl. 701/301

(57) ABSTRACT

The object of the invention is to provide driving support with appropriate timing for both obstacles that can be visually recognized by the driver of a vehicle and obstacles that are visually unrecognizable to the driver. When an obstacle is detected, whether the obstacle is a first-type obstacle that is visually recognizable to the driver of a vehicle or a second-type obstacle that is visually unrecognizable to the driver is determined (S2), the collision risk (base value) for each kind of obstacle is modified and adjusted such that the collision risk of a second-type obstacle is larger than the collision risk of a first-type obstacle (S3). In addition, the collision risk R2 of a second-type obstacle is compared with a threshold value Rc, and when R2≧Rc, a warning is output for the second-type obstacle (S5). Moreover, when R2<Rc, the collision risk RI of a first-type obstacle is compared with a threshold value Rcc, and when R1≧Rcc, it is determined that there is danger of a collision, and auto braking or evasive steering (S7) are performed. By doing so driving support is performed with appropriate timing for both obstacles that are visually recognizable to the driver of a vehicle and obstacles that are visually unrecognizable to the drive, and safety is maintained.

### CROSS REFERENCE TO RELATED APPLICATIONS

This application claims priority under 35 U.S.C. 119 based upon Japanese Patent Application Serial No. 2008-196583, filed on Jul. 30, 2008. The entire disclosure of the aforesaid application is incorporated herein by reference.

### FIELD OF THE INVENTION

The present invention relates to a driving support apparatus for vehicle that becomes aware of the surrounding conditions of the vehicle in which it is installed, and provides driving support to the driver of that vehicle.

### BACKGROUND OF THE INVENTION

Recently, technology is being developed and applied to vehicles such as automobiles, in which cameras, laser radar or the like are mounted in a vehicle and used to detect the conditions outside the vehicle while the vehicle is moving in order to become aware of any obstacles that the vehicle could collide with; and by performing various controls such as warning alarms, auto braking, auto steering or the like, makes it possible to avoid collision with the obstacle and thus improve safety.

Also, since it is not possible to detect objects that are not in the range of view of the driver with the cameras or radar described above, recently technology is being developed in which by communicating with an apparatus outside of the vehicle, it is possible to obtain information other than what is in the field of view of the driver.

For example, in Japanese unexamined patent application publication no. 2006-309445, a support apparatus is disclosed that reads necessary map data for an area based on information that is received from GPS, and then based on that map data, estimates the path of the vehicle and obstacles, and when the path of the vehicles crosses that of an obstacle, issues a warning.

However, in the prior technology such as that disclosed in Japanese unexamined patent application publication no. 2006-309445, warnings are issued at the same timing for vehicles that the driver of a vehicle sees and does not see, so not only does a driver feel annoyed by warnings for vehicles that the driver can see, that is vehicles that the driver is obviously aware of, but there is a possibility that warnings for vehicles that the driver cannot see, or in other words, vehicles that the driver is unaware of, may be delayed.

Taking the aforementioned problems into consideration, it is an object of the present invention to provide a vehicle driving support apparatus that is capable of providing timely driving support of detecting obstacles that are visually recognizable to the driver of the vehicle and obstacles that are visually unrecognizable to the driver.

### SUMMARY OF THE INVENTION

In order to accomplish the object of the present invention described above, the driving support apparatus for vehicle of the present invention is a vehicle driving support apparatus for recognizing conditions surrounding a vehicle and providing driving support to a driver of the vehicle includes

an obstacle determination unit configured to detect an obstacle existing outside of the vehicle, and to determine whether said obstacle is a first-type obstacle that is visually recognizable by the driver, or a second-type obstacle that is visually unrecognizable by the driver; and

a driving support setting unit configured to set driving support for avoiding a collision with said obstacle, wherein a collision risk of the second-type obstacle is evaluated as being higher than a collision risk of the first-type obstacle.

With the present invention, it is possible to perform driving support with appropriate timing for both obstacles that are visually recognizable by the driver of a vehicle and obstacles that are visually unrecognizable by the driver, and safety can be maintained without annoyance to the driver.

### BRIEF DESCRIPTION OF THE DRAWINGS

FIG. 1 is a schematic drawing of a driving support apparatus mounted in a vehicle, related to a first embodiment of the present invention.

FIG. 2 is an explanative drawing showing the range of recognition of obstacles at an intersection, related to the first embodiment of the present invention.

FIG. 3 is a flowchart of a warning determination process, related to the first embodiment of the present invention.

FIG. 4 is an explanative drawing showing the paths of movement of the vehicle and an obstacle at a crossroad, related to a second embodiment of the present invention.

FIG. 5 is an explanative drawing showing the paths of movement of the vehicle and an obstacle on the same road, related to the second embodiment of the present invention.

FIG. 6 is an explanative drawing showing the path of movement of the vehicle and an obstacle at an intersection, related to the second embodiment of the present invention.

### DETAILED DESCRIPTION OF THE INVENTION

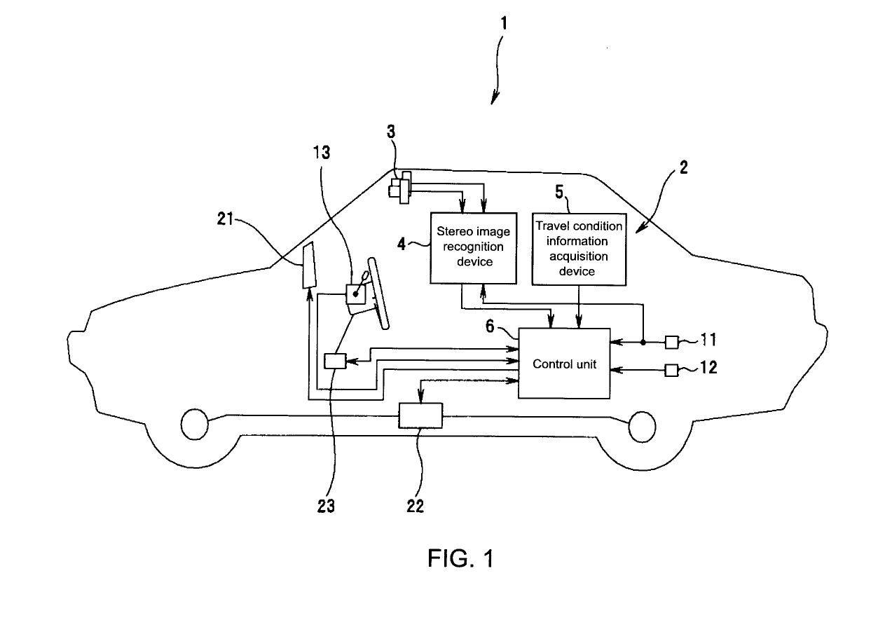

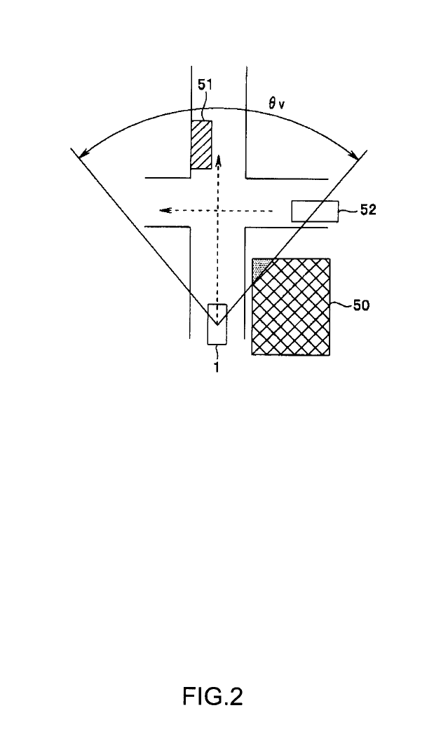

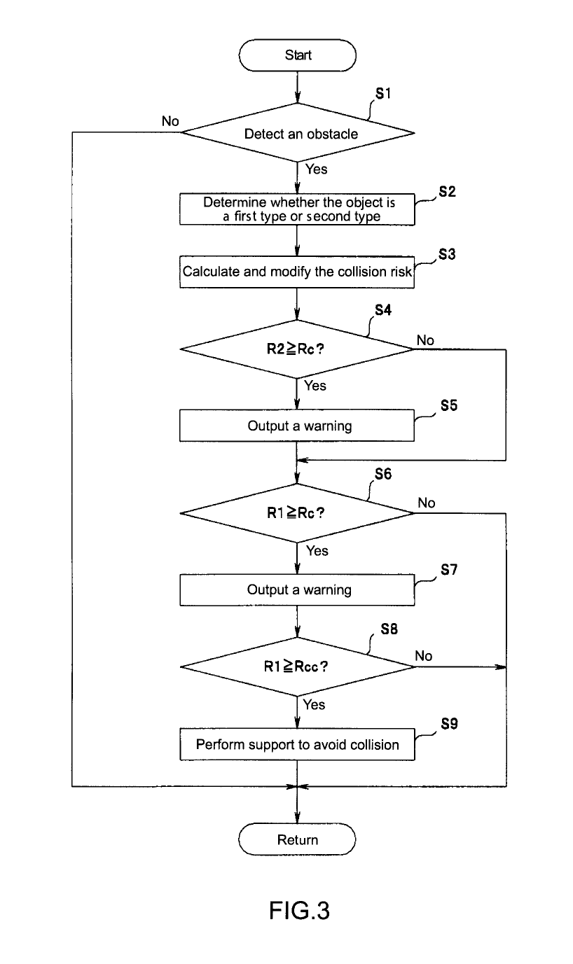

In the following, preferred embodiments of the present invention will be described in detail with reference to the accompanying diagrams. FIG. 1 to FIG. 3 relate to the first embodiment of the present invention, where FIG. 1 is a schematic drawing of a driving support apparatus that is mounted in a vehicle; FIG. 2 is an explanative drawing showing the range of recognition of obstacles at an intersection; and FIG. 3 is a flowchart of a warning determination process.

In FIG. 1, reference number 1 is a vehicle such as an automobile, and a driving support apparatus 2 that recognizes the outside traveling conditions and provides driving support to the driver is mounted in this vehicle 1. In this embodiment of the present invention, the driving support apparatus 2 mainly comprises: a devices group for recognizing the outside conditions that includes a stereo camera 3, a stereo image recognition device 4 and a traveling condition information acquisition device 5; and a control unit 6 that includes a microcomputer or the like that performs various processes for driving support based on information from each of the devices. The control unit 6 is connected to various devices related to driving support such as a display 21 that also functions as a warning device, an auto-brake control device 22 and an auto-steering control device 23.

The stereo image recognition device 4, travel condition information acquisition device 5, control unit 6, auto-brake control unit 22 and auto-steering control device 23 form a control unit comprising one or a plurality of computer systems, and exchange data with each other via a communication bus.

In addition, a speed sensor 11 that detects the speed V of the vehicle, a yaw rate sensor 12 that detects the yaw rate, and a main switch 13 to which the ON-OFF signal of the driving support control is input are provided in the vehicle 1. The vehicle speed V is input to the stereo image recognition unit 4 and control unit 6, the yaw rate is input to the control unit 6, and the ON-OFF signal for driving support control is input to the control unit 6.

The stereo camera 3 and stereo image recognition device 4 form a first detection device that detects an obstacle using visible light, and have an imaging range that is approximately the same as the range of view of the driver of the vehicle. The stereo camera 3 comprises a pair of cameras (left and right cameras) that use solid-state image sensors such as CCD or CMOS, with each camera being installed, having a constant base line length, on the ceiling at the front of the inside the vehicle such that each camera takes stereo images of a target outside the vehicle from different view points and outputs image data to the stereo image recognition device 4.

The stereo image recognition device 4 comprises an image processing engine that processes images taken by the stereo camera 3 at high speed, and functions as a processing unit that performs recognition processing based on the results outputted from this image processing engine. Processing of images of the stereo camera 3 is performed in the stereo image recognition device 4 as described below.

In other words, the stereo image recognition device 4 first finds distance information from the amount of shifting of the corresponding positions for the pair of stereo images in the direction of travel of the vehicle 1 that were taken by the stereo camera 3, and generates a range image. Based on this range image, a well-known grouping process is performed and together with performing a comparison with a frame (window) of three-dimensional road shape data, side wall data, solid object data, and the like that are stored in memory in advance and extracting white line data, and data about roadside objects such as guardrails or curbstones that exist along the road, the stereo image recognition device 4 classifies and extracts solid object data as motorcycles, normal vehicles, large vehicles, pedestrians, power poles and other solid objects. With the vehicle as the origin, these data are calculated as vehicle based coordinate data with the forward-backward direction of the vehicle 1 being the X axis and the width direction of the vehicle being the Y axis, and the white line data, sidewall data such as guardrails or curbing that run along the road, type of solid object, distance from the vehicle 1, center position, and speed are transmitted to the control unit 6 as obstacle information.

The travel condition information acquisition device 5 forms a second detection device that detects obstacles without using visible light, and can detect objects in a wider range than the object detection range of the stereo camera 3. More specifically, the travel condition information acquisition device 5 functions as a device that is capable of acquiring a wide range of travel condition information by collecting various information from devices such as: a road-to-vehicle communication device that acquires various information such as traffic information, weather information, traffic regulation information for a specific area, and the like by receiving optical or radio beacons from road fixtures; a vehicle-to-vehicle communication device that performs communication (vehicle-to-vehicle communication) with other vehicles that are in the vicinity of the vehicle, and exchanges vehicle information such as vehicle type, vehicle position, vehicle speed, acceleration/deceleration state, braking state, blinker state, and the like; a position measurement device such as GPS; and navigation device, and based on this information, is able to detect obstacles that are within the field of view but are hidden by buildings and the like, therefore visually unrecognizable to a driver.

Based on the vehicle speed V from the vehicle speed sensor 11, the yaw rate from the yaw rate sensor 12, obstacle information from the stereo image recognition device 4 and obstacle information from the travel condition information acquisition device 5, the control unit 6 identifies obstacles around the vehicle as first-type obstacles that are visually recognizable by the driver of the vehicle, and second-type obstacles that are visually unrecognizable to the driver of the vehicle. The control unit 6 also determines the collision risk, which indicates the degree of collision risk with each obstacle, and when the collision risk indicates a possibility of collision that is equal to or greater than a set value, performs driving support to avoid collision by outputting a warning to the driver via the display 21, performing forced deceleration via the auto-braking control device 22, and/or performing evasive steering via the auto-steering control device 23.

When doing this, the control unit 6 evaluates the collision risk of second-type obstacles as being higher than that of first-type obstacles, and performs driving support such as issuing a warning. In other words, the risk level to start the driving support varies depending on whether the obstacle is visually recognizable or not by the driver, such that the driving support, such as warnings or the like, is performed more aggressively when the obstacle is unrecognizable by the driver. Therefore, it is possible to perform suitable driving support such as issuing a warning for an obstacle that the driver cannot visually recognize or issuing a warning for a suitable object at suitable timing, without performing driving support that could be an annoyance to the driver such as issuing a warning for obstacles that the driver is aware of. This type of function by the control unit 6, is represented by an obstacle determination unit that determines whether an obstacle is a first-type obstacle or second-type obstacle, and a driving support setting unit that sets the driving support for avoiding collision by giving priority to second-type obstacles over first-type obstacles when determining collision risk.

In the identification and determination of first-type obstacles and second-type obstacles by the function as an obstacle determination unit, determination can be performed based on whether or not the same obstacle was detected by the stereo image recognition device 4 (stereo camera 3) and the travel condition information acquisition device 5. Whether or not the same obstacle is detected by the stereo camera 3 (stereo image recognition device 4) and the travel condition information acquisition device 5 can be determined from the position or speed of the detected obstacle.

An example of an intersection as shown in FIG. 2 where there is no traffic signal and there is a building 50 on the right will be explained below. When the vehicle 1 approaches the intersection, there are two obstacles: a first vehicle 51 that is parked in front near the intersection, and a second vehicle (another oncoming vehicle) 52 that is traveling toward the intersection from the road on the right, where in this kind of condition, the first vehicle 51 in the front is in the range of view (view angle θv) of the stereo camera 3, and is recognized by the stereo image recognition device 4. However, the second vehicle 52 that is traveling from the right is blocked by the building 50 and not seen in the image from the stereo camera 3, so the vehicle cannot be recognized by the stereo image recognition device 4 and is detected by the travel condition information acquisition device 5 from a vehicle-to-vehicle or road-to-vehicle communication signal.

The first vehicle 51 that is detected by the stereo camera 3 is an obstacle that is in the range of view of the driver of the vehicle and can be visually recognized by the driver, while the second vehicle 52 that is not detected by the stereo camera 3 is hidden by the building 50 and cannot be seen by the driver, and is an obstacle that cannot be recognized by the driver. Therefore, in the case where the stereo camera 3 (stereo image recognition device 4) and the travel condition information acquisition device 5 do not detect an identical obstacle, e.g., the second vehicle 52 is detected only by the travel condition information acquisition device 5 and is not detected by the stereo camera 3, the second vehicle 52 is determined to be an second-type obstacle that is visually unrecognizable to by the driver of the vehicle. On the other hand, in the case where the first vehicle 51 is at least detected by the stereo camera 3, the first vehicle 51 is determined to be a first-type obstacle that can be visually recognized by the driver of the vehicle.

It is possible to use detection devices such as a laser radar, millimeter-wave radar, infrared camera, ultrasonic wave detector or the like as a second detection device that is not based on visible light. By using wide-angle cameras that are capable of taking images of a range that is wider than the field of view of the driver for the stereo camera 3, and by presetting the image area that corresponds to the field of view of the driver, it is possible to omit the second detection device.

Furthermore, through the function as a driving support setting unit, the control unit 6 evaluates the collision risk of the second vehicle 52 (second-type obstacle) as being higher than the collision risk of the first vehicle 51 (first-type obstacle). The collision risk of an obstacle will be explained below. The collision risk of an obstacle can be calculated based on the time that the vehicle and the obstacle will arrive at an intersection, or on the probability that an obstacle exists.

When using the arrival time at an intersection, by taking the distance from an obstacle i to the center of the intersection to be Di, the speed of the obstacle i to be Vi, the distance from the vehicle 1 to the center of the intersection to be D, the speed of the vehicle to be V, the time until the obstacle i reaches the center of the intersection to be Ti (Ti=Di/Vi), and the time until the vehicle 1 reaches the center of the intersection to be T (T=D/V), by calculating the difference in time and taking the inverse, the collision risk R, which expresses the danger that the position of vehicle 1 will overlap with the position of the obstacle i is calculated as shown in Equation (1) below.

R=1/(Ti+|Ti−T|) (1)

Also, when calculating the collision risk R based on the probability that an obstacle exists, by using the variances σx, σy in the XY axis direction that are set according to the recognition accuracy and existence status of an obstacle, the collision risk R is calculated as a function of the existence position (x, y) as shown in Equation (2).

R=G·exp(−((Xi−x)²/(2·σx²))−((Yi−y)²/(2·σy²))) (2)

where
G: Preset gain
Xi: X coordinate position of the obstacle i (center position)
Yi: Y coordinate position of the obstacle I (center position)

The variances σx, σy are set larger, the lower the recognition accuracy is. Also, when the object type is a pedestrian or a bike, the variances σx, σy can be set large, using a normal vehicle and a large vehicle as a reference, and when the obstacle is some other kind of object, the variances σx, σy can be set low.

The collision risk R, calculated from either equation (1) or equation (2) above, is used as a base value of the risk, and depending on whether the target obstacle is a first-type obstacle or a second-type obstacle, the base value R of the risk is multiplied by a different coefficient k, or by using a different threshold value Rc for comparison of the collision risk when determining whether to perform driving support such as a warning, the collision risk R is modified so that the collision risk of a second-type obstacle is evaluated as being higher than the collision risk of a first-type obstacle.

For example, when the collision risk of a first-type obstacle is taken to be R1 and the collision risk of a second-type obstacle is taken to be R2, by multiplying the base value R of the collision risk by a value of coefficient k that is k=1 for a first-type obstacle, and a value of coefficient k that is k>1 for a second-type obstacle, the collision risk is modified such that it is greater than when the driver can visually recognize the obstacle. Alternatively, by setting the threshold value Rc that is compared with the collision risk such that the threshold value Rc1 for a first-type obstacle is higher than the threshold value Rc for a second-type obstacle, the collision risk R2 of a second-type obstacle can be evaluated as being higher than the collision risk R1 of a first-type obstacle.

In this embodiment, when considering a first-type obstacle to be an obstacle that is naturally recognized by the driver of the vehicle, determining whether or not a warning is necessary is performed by keeping the collision risk R1 of a first-type obstacle as is and modifying the collision risk of a second-type obstacle such that it becomes larger. Next, an example of processing by a program related to this warning determination is explained using the flowchart shown in FIG. 3.

In the processing by this program, first, in step S1, whether or not an obstacle has been detected is checked. When an obstacle is not detected, this processing ends, however, when an obstacle is detected, then in step S2, whether the obstacle is a first-type obstacle that can be visually recognized by the driver of the vehicle, or a second-type obstacle that is visually unrecognizable to the driver is determined.

Next, proceeding to step S3, the collision risk (base value) R of each obstacle is calculated, and that base value R is modified by a coefficient k according to whether the obstacle is a first-type obstacle or second-type obstacle, and adjusted such that, when compared to the collision risk of an obstacle that is visually recognizable by the driver, the collision risk R2 of a second-type obstacle is a larger. Moreover, in step S4, the collision risk R2 of a second-type obstacle is compared with a threshold value Rc, and when R2≧Rc, a warning is output in step S5 and processing advances to step S6, however, when R2<Rc, processing jumps to step S6.

In step S6, the collision risk R1 of a first-type obstacle is compared with the threshold value Rc, and when R1≧Rc, a warning is output in step S7 and processing advances to step S8, however, when R1<Rc, this processing ends. In other words, no warning is output unless the collision risk is sufficiently high, thus lowering the annoyance of a warning.

In step S8, the collision risk R1 of a first-type obstacle is compared with a threshold value Rcc. This threshold value Rcc is a threshold value for determining the risk level that requires maneuvering to avoid a collision, and is set to a value that is greater than the threshold value Rc for a warning.

When the result of comparison of the collision risk R1 and threshold value Rcc in step S8 is R1<Rcc, it is determined that there is no possibility of a collision, and this processing ends. On the other hand, when R1≧Rcc, it is determined that there is a possibility of collision and processing proceeds from step S8 to step S9, and safety is maintained by performing forced braking via the auto-brake device 22 or evasive steering via the auto-steering control device 23. In other words, the processing of this step S9 is executed when there is insufficient evasive manipulation by the driver in spite of a warning that has been output for a first-type obstacle, or when there is insufficient evasive manipulation by the driver when a second-type obstacle enters the field of view of the driver and is determined to be a first-type obstacle.

In this embodiment, there is a high possibility that an obstacle that can be detected by a visible light camera such as a stereo camera 3 can be visually recognized by the driver, so a warning for that obstacle is set more difficult to output. This makes it possible to reduce the annoyance of a warning. Moreover, it is possible to issue warnings at a suitable timing for obstacles that cannot be visually recognized by the driver.

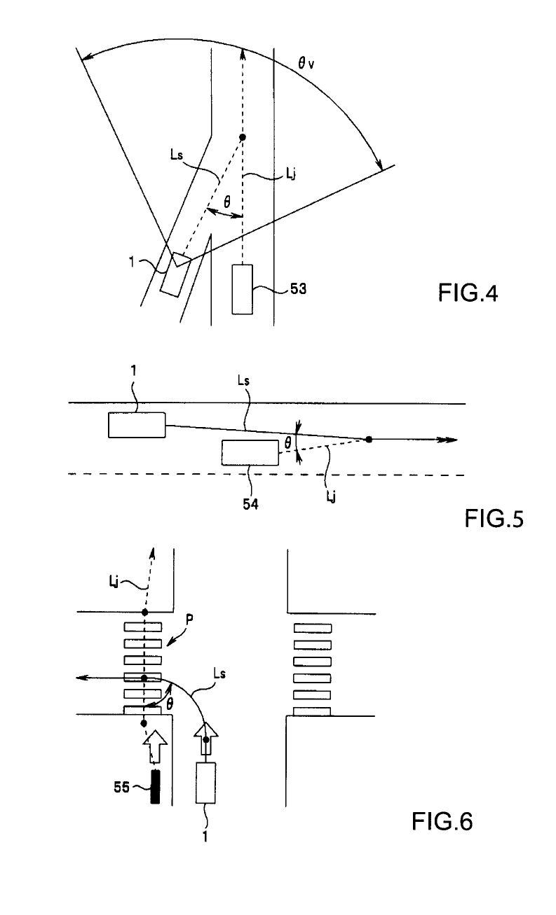

Next, a second embodiment of the present invention will be explained. FIG. 4 to FIG. 6 are related to this second embodiment of the invention; where FIG. 4 is an explanative drawing showing the movement path of the driver's own vehicle and an obstacle at a crossroad; FIG. 5 is an explanative drawing showing the movement path of the driver's own vehicle and an obstacle on a single road; and FIG. 6 is an explanative drawing showing the movement path of the driver's own vehicle and an obstacle at an intersection.

This second embodiment predicts the movement paths of the vehicle and obstacles, and based on the crossing state of the predicted movement paths, determines whether or not the obstacle is a second-type obstacle that is difficult for the driver of the vehicle to see.

For example, as shown in FIG. 4, a condition in which the vehicle 1 is traveling along a road that crosses in a Y shape is presumed. Here, the stereo camera 3 of the vehicle 1 does not detect an obstacle that is in its imaging range, however, through vehicle-to-vehicle or road-to-vehicle communication, the travel condition information acquisition device 5 detects another vehicle 53 (obstacle) that is traveling along another road.

In this kind of state, the control unit 6 calculates the estimated movement path Lj of the other vehicle 53 based on information such as the position, speed, acceleration, blinker indications of the other vehicle 53, and map data, and also calculates the estimated movement path Ls of the vehicle 1 based on information such as the position, speed, acceleration, blinker indications of the vehicle 1, and map data. These movement paths Lj, Ls can be estimated by calculating the position of each vehicle in a XY coordinate system based on the driver's vehicle for specified time periods based on the current velocity.

Next, the control unit 6 checks whether or not the movement paths Lj, Ls cross, and as shown by the dashed lines in FIG. 4, when the movement path Lj of the other vehicle 53 crosses the movement path Ls of the vehicle 1, the control unit 6 calculates the angle θ at which both paths cross. In addition, the control unit 6 compares the angel of crossing θ with a preset value, and when the crossing angle θ is less than the set value, the other vehicle 53 is determined to be a second-type obstacle that is difficult for the driver of the vehicle 1 to see, and by modifying the collision risk R described above by a coefficient k or threshold value Rc, it is possible to warn the driver with suitable timing.

In this case, even when the crossing angle θ is less than the set value, by further checking the positional relationship between the obstacle and the vehicle based on position information and map data, it is also possible to handle situations such as shown in FIG. 5 in which the vehicles are traveling along a single road. In other words, the movement path Ls of the vehicle 1 and the movement path Lj of the obstacle 54 are calculated, and even when the crossing angle θ between both movement paths is less than a set angle, whether or not the obstacle 54 is moving along the same road (same lane) as the vehicle 1 is further determined based on the respective position information and map data of each.

When the obstacle 54 is moving along the same lane as the vehicle 1, together with determining the type of obstacle 54, the orientation of the obstacle 54 at the current point of the movement path and the orientation of the vehicle are found. As a result, when it is found that the obstacle 54 is a vehicle, and the orientation of both is nearly the same, the obstacle 54 is determined to be a first-type obstacle that can be visually recognized by the driver of the vehicle 1, so issuing an unnecessary warning is stopped, however, when the type of the obstacle 54 is determined to be a vulnerable user of the road such as a pedestrian or bicycle, or a motorcycle, and when the orientation of both is the same, the obstacle is determined to be a second-type obstacle that is visually unrecognizable by the driver, and a warning or the like is issued.

On the other hand, in a situation in which the vehicle 1 is making a left turn (or a right turn) at an intersection, then as shown in FIG. 6, the crossing angle θ between the movement path Ls of the vehicle 1 and the movement path Lj of an object (obstacle) 55 such as a pedestrian or bicycle that is crossing a crosswalk P will not become less than the set value. In a situation such as this as well, it is possible to provide suitable driving support by finding the type and the orientation of the object 55.

In other words, when the crossing angle θ between the movement paths of the vehicle and an obstacle is greater than the set value, the type of the obstacle is obtained and when the type of the obstacle is a vulnerable user of the road such as a pedestrian or bicycle, or a motorcycle, and when the orientation of the object 55 at its current point on the movement path is nearly the same as the orientation of the vehicle 1, the object 55 is determined to be a second-type obstacle that is visually unrecognizable for the driver of the vehicle 1, so a warning such as a sound or display is issued. Also, when the type of the obstacle is a 4-wheeled vehicle, a warning is issued that is a display only with no sound.

In this second embodiment, by finding the relationship between the movement path of an obstacle and the movement path of the vehicle in this way, whether the obstacle is a second-type obstacle that is difficult for the driver of the vehicle to see is determined. In a situation, such as a point where roads merge together, in which another vehicle is approaching the driver's vehicle from the rear, when the crossing angle θ between the movement paths of each is small, the obstacle is determined to be a second-type obstacle that is visually unrecognizable by the driver and timely driving support is provided by issuing a warning or the like.

Even when the crossing angle θ is small, by finding the type and orientation of an obstacle, it is possible to identify that a vehicle is traveling on the same road (a vehicle in front or behind) and prevent issuing an unnecessary warning, and in the case of a pedestrian, bicycle, motorcycle or the like that the driver is not aware of, it is possible to maintain safety by bringing the driver's attention to it.

Furthermore, even when the crossing angle θ during a left turn or right turn at an intersection is large, by finding the type and orientation of the obstacle, the obstacle is identified as a pedestrian, bicycle or the like, and it is determined that there is a possibility of a problem during a left turn, or of a collision at the crosswalk after making a left or right turn, so it is possible to provide a timely warning.

In this second embodiment, the first detection device (stereo camera 3 and stereo image recognition device 4) that detects obstacles using visible light is not absolutely necessary, and it is possible to apply the embodiment in the case where just the second detection device (travel condition information acquisition device 5) is mounted in the vehicle 1.

What is claimed is:

1. A driving support apparatus for vehicle for recognizing conditions surrounding the vehicle and providing driving support to a driver of the vehicle, comprising:
an obstacle determination unit configured to detect an obstacle existing outside of the vehicle, and to determine whether said obstacle is a first-type obstacle that is visually recognizable by the driver, or a second-type obstacle that is visually unrecognizable by the driver; and
a driving support setting unit configured to set driving support for avoiding a collision with said obstacle, wherein a collision risk of the second-type obstacle is evaluated as being higher than a collision risk of the first-type obstacle.

2. The driving support apparatus for vehicle of claim 1, wherein
said obstacle determination unit detects an obstacle using a first detection device that uses visible light, and a second detection device that does not use visible light, and determines whether said obstacle is the first-type obstacle or the second-type obstacle based on whether said obstacle was detected by both the first detection device and the second detection device.

3. The driving support apparatus for vehicle of claim 2, wherein
when an obstacle that is detected by the second detection device is not detected by the first detection device, said obstacle is determined to be a second-type obstacle.

4. The driving support apparatus for vehicle of claim 1, wherein
said obstacle determination unit determines whether an obstacle is a first-type obstacle or a second-type obstacle according to a crossing angle between a movement path that is estimated for the vehicle and a movement path that is estimated for the obstacle.

5. The driving support apparatus for vehicle of claim 4, wherein
if said crossing angle is less than a set value, said obstacle is determined to be a second-type obstacle.

6. The driving support apparatus for vehicle of claim 5, wherein
if said second-type obstacle is determined to be traveling along the same road as said vehicle even though the crossing angle is less than the set value, the driving support setting unit does not perform driving support for said second-type obstacle.

7. The driving support apparatus for vehicle of claim 4, wherein
if said crossing angle is a set value or greater and the orientations of said movement paths at the current point are nearly the same, said obstacle is determined to be a second-type obstacle.

8. The driving support apparatus for vehicle of claim 1, wherein
said driving support setting unit sets the collision risk of a second-type obstacle higher than the collision risk of a first-type obstacle.

9. The driving support apparatus for vehicle of claim 1, wherein
said driving support setting unit sets warning output based on the collision risk as the driving support for avoiding a collision, such that the timing of a warning output for a second-type obstacle is earlier than the timing for a warning output for a first-type obstacle.

10. The driving support apparatus for vehicle of claim 1, wherein
said driving support setting unit sets only a warning display for a first-type obstacle as the driving support when a first-type obstacle is detected and a second-type obstacle is not detected.
